(19) United States
(12) Patent Application Publication
(10) Pub. No.: US 2009/0052645 A1
(43) Pub. Date: Feb. 26, 2009

(54) TELECONFERENCE SYSTEM WITH PARTICIPANT FEEDBACK

(76) Inventors: Ravi Prakash Bansal, Tampa, FL (US); Rick Allen Hamilton, II, Charlottesville, VA (US); Brian Marshall O'Connell, Cary, NC (US); Keith Raymond Walker, Austin, TX (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(21) Appl. No.: 11/843,081

(22) Filed: Aug. 22, 2007

(51) Int. Cl. H04M 3/56; H04N 7/15

(52) U.S. Cl. 379/202.01; 348/14.08

(57) ABSTRACT

A method, medium and implementing processing system are provided for facilitating teleconference-based meeting moderation by the addition of a “live feedback” feature, with instrumentation such as by means of an instant messaging systems when instant messaging conference systems equipped with this feature are used to supplement teleconferences, the participants provide instant feedback (anonymously, if desired) to the meeting moderator. The audience can let the moderator know their valuation of the current discussion. Based on feedback, the moderator can take appropriate action, such as to steer the conversation into areas that will be received favorably by the meeting participants.

### FIELD OF THE INVENTION

The present invention relates generally to information processing systems and more particularly to a methodology and implementation for processing teleconference communications.

### BACKGROUND OF THE INVENTION

Currently, audience feedback metering is often used for evaluating speeches, seminar presentations or contestants' performances in song, dance and sports competitions. In these situations, the goal is to evaluate the presenter for their presentation, speech, singing/dancing or some other ability. Another popular example is the presidential debate series where such systems are used to measure an audience's live reaction to a candidate's speech. These solutions normally require extensive set up that may include creating a live web-based polling system or a telephone line bank for telephone-based polling or using individual hardware devices that are provided to a panel of people who can enter their feedback into the devices for subsequent measurement. Because of effort involved, these solutions are used during specific events, such as the ones mentioned above, and are unsuited for the purpose of measuring participant feedback for facilitation of everyday business meetings and the like.

There also exist webcast or web-seminar software systems that utilize instant polling mechanisms to gauge audience feedback. These solutions require the webcast or web-seminar moderator to take specific actions to set up the questions of the poll and to actively solicit feedback. These kinds of feedback systems enable a moderator to get feedback at specific times in a survey format but do not provide real-time live reaction measurement capability.

Further, many businesses are adopting telecommuting in the workplace. With an increase in telecommuting, traditional meetings that took place in a conference room are being replaced by telephone conferences. In telephone conferences, participants located at various locations dial into a “conference call.” Using a telephone as a communications medium restricts information transfer to only verbal communication. Sometimes the telephone conferences are supplemented by instant message conferences or web conferences so that the participants can share presentations or exchange text messages with each other. One of the drawbacks of teleconferences is the attenuation of immediate feedback from participants. It is difficult for a meeting moderator to determine if participants are reacting favorably to the current topic of discussion. In the absence of visual cues such as body language and facial expressions, the meeting moderator is also unable to determine the interest level of the participants. In many cases, the meeting moderator has to specifically solicit participants for feedback such as asking questions to gauge if the participants agree with the current direction the meeting is headed. In other cases, the moderators have to use their own judgment to direct the meeting which may add the risk of alienating participants.

Therefore, a solution is needed to provide meeting moderators with automated means to continuously monitor instant participant feedback on the quality of a teleconference meeting that they are moderating.

### SUMMARY OF THE INVENTION

A method, medium and implementing processing system are provided for facilitating teleconference-based meeting moderation by the addition of a “live feedback” feature, with instrumentation such as by means of an instant messaging systems. When instant messaging conference systems equipped with this feature are used to supplement teleconferences, the participants provide instant feedback (anonymously, if desired) to the meeting moderator. The audience can let the moderator know their valuation of the current discussion. Based on feedback, the moderator can take appropriate action, such as to steer the conversation into areas that will be received favorably by the meeting participants. In an exemplary embodiment, a first communication channel is established for conducting an audio or video teleconference and a second communication channel is established between a meeting moderator and members or participants of the audience or meeting. The first channel enables the moderator to conduct the meeting while the second or parallel channel enables the participants to provide instant real-time feedback to the material being presented.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of one embodiment of a system in which the present invention may be implemented;

FIG. 2 is a block diagram showing several of the major components of a user communication device in accordance with the present invention;

FIG. 3 is a flow chart illustrating an exemplary operation of one processing function implemented in accordance with the present invention;

FIG. 4 is a flow chart illustrating an exemplary operation of a second processing function implemented in accordance with the present invention; and

FIG. 5 is a flow chart illustrating an exemplary operation of a third processing function implemented in accordance with the present invention.

### DETAILED DESCRIPTION

The various methods discussed herein may be implemented within a communication system which includes processing means, memory, updateable storage, input means and display means. Since the individual components of a communication system which may be used to implement the functions used in practicing the present invention are generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention. Although the invention is illustrated in the context of a hard-wired audio teleconference, it is understood that wireless cellular or other wireless systems may also be implemented to achieve the beneficial functional features described. Further, it is understood that the principles of the invention may be implemented in any of many available and future communication devices and systems.

The present invention provides for the participants to provide feedback continuously in real time. The feedback is collected, analyzed and rendered, for example, as a moving graph on a feedback window presented to the moderator for immediate feedback. This provides the moderator with a “situational awareness” of how a teleconferenced meeting or presentation is going at all times.

Another advantage of the present invention is its automation that allows efficient management of meetings, i.e. the moderator does not have to manually set up instant polls and actively take the time to solicit feedback and analyze the feedback every so often. The participants can provide the feedback on their own, resulting in time savings.

In accordance with the present invention, methods are provided to enable a meeting moderator to obtain continuous, real-time feedback for the current discussion during teleconferences. These ratings can be used to assess the applicability of the discussion and potentially allow the moderator to change the course of the discussion. The methodology of the present invention may be applied to Instant Messaging (IM) conferences, web conferences, web services and other networked communication systems and arrangements.

In one exemplary embodiment, a histogram (not shown), or other type of bar chart or graphic device is used to show the number of participants selecting each discrete choice, rather than, or in addition to, the average value. Other specific implementations include the use of a slider bar rather than discrete choices. Further, a two-dimensional selection may also be implemented in which interest along one axis and level-of-detail along another axis are displayed. In another example, the use of VOIP allows participants to enter feedback via telephone keypad.

In the following disclosed exemplary embodiment, during a telephone conference call, a moderator starts an instant messaging conference and invites participants of the meeting to that instant messaging conference. In addition, the moderator starts the “live feedback” feature as hereinafter described. Upon feature activation, graphical feedback buttons, which made be either hardware or software implemented, and are labeled, for example, “positive”, “negative” and “neutral” are enabled in each participant's display device in a personal conference window. Depending on the embodiment, the buttons may represent any kind of feedback such “Too verbose,” “Bad Topic,” “Good Point”, etc. The buttons may also allow participants to type in text comments, or select predetermined generic text comments.

In one example, on the moderator's instant messaging window presented on his display device, a feedback meter is rendered. The moderator may share this with others if he/she wishes to. During the conference call, the participants can, anonymously, provide feedback (and type in any comments) on the relevance of current conversation. The favorability percentage is computed, which includes methods to appropriately average the favorability depending on the participants. It is to be noted that feedback meter is continuously updating as time progresses as opposed to discrete poll results. The moderator's meter reflects the feedback collected and based on this, the moderator can determine whether the participants are interested or not in the discussion that is occurring and, based on the feedback, the moderator can take appropriate action to steer the conversation into areas that will be received more favorably.

This feature is very useful to moderators of teleconferences who are interested in making the most efficient use of meeting time. They can easily determine if—in view of the majority of participants—the meeting is wasting time or discussing something useful. They may receive other participants opinions in real time without the need for manually polling participants. Having a live anonymous system that takes into account a majority's opinions also assures the moderator that if they steer the discussion in a certain direction, they will not risk alienating a majority of the participants. The disclosed invention makes a 2-way live feedback loop ability universally available to every business meeting at a “consumer level”. The current solution is a continues feedback system that does not require a moderator to setup and repeatedly poll conference members.

The following example uses an IM system although it is noted that similar methods may be used for other input solutions such as web sites, web services, phone input, etc. The present example illustrates a new computer processing system method that can be added to instant messaging software. In the exemplary embodiment illustrated, the processing includes three basic routines.

The first routine, running within the IM client software that runs on the moderator's workstation, is activated when a meeting moderator starts an instant messaging conference, invites participants and activates the “live feedback” feature by pressing a graphical button or selecting a menu option selection. With this feature enabled, this routine sends a signal to the instant message client software running on all the participant's personal computers. This activates a second routine running on the participant's personal computer that activates the feedback buttons on the participants, personal conference windows. Depending on the embodiment, the buttons may represent any kind of feedback such as “positive”, “negative” or “neutral”, “bad topic”, “interesting topic”. The buttons may also allow participants to type in text comments such as “too verbose” or “excellent point”, etc.

In addition, on the moderator's personal instant messaging window, the first routine displays a feedback device, for example a meter showing a graph of the feedback. Depending on the embodiment, this can be a running line graph that ascends or descends based on feedback or a bar graph showing number of responses in each feedback category. While the meeting is active, the second routine - running within the client instant messaging software that runs on each participant's workstation - monitors for feedback button presses or comments. Once it receives a button press event, it determines the particular feedback option selected and sends a signal to a third routine. It is to be noted that in another embodiment of the invention, the second routine that runs within the client software running on the participants' workstations may prevent a single participant from giving excessive feedback that could lead to an unnecessary bias in the feedback results. The client software may do this by ignoring more than a specific number of feedback button presses within a given time period.

The third routine running within the IM client software that runs on the moderator's workstation, monitors reception of a signal from the participants (that is, from the second routine running on participants' workstations) containing feedback data. Once it receives such a signal, it retrieves feedback data from signal and collates it. It assigns a mark or rank to each selected feedback option received from a participant and then calculates and maintains the present feedback score. Detecting the present feedback score requires analyzing feedback in distinct quanta. The first vote received starts a new data collection quanta. As each 5 additional vote is received, the quanta is extended by some fraction of the original quanta. If the quanta expires the next vote starts a new quanta. For example, consider a system selects a quanta time of 20 seconds and a quanta extension per additional vote of ⅕ quanta. The first person votes and a new quanta is started, a second person votes 6 seconds later extending the total quanta to 24 seconds (⅕th of 20). A third person votes at quanta start +14 extending the quanta to 28 seconds. Finally at quanta start+35 a vote is cast which starts a new 20 second quanta. It should be noted that this simple quanta system is exemplary in nature and embodiments may implement more accurate quanta delineation system while not deviating from the spirit of the disclosed invention.

A running average of overall feedback score is determined by summing the feedback and dividing by number of participants. Subsequently, the results are formatted for graphical display and those results are displayed on the feedback meter. These routines can continue to run for the duration of the instant message conference or until the moderator de-activates the live feedback option.

The proposed invention is not limited to instant messaging but may also allow feedback using a web site, web service or through the interception of a user's phone keypresses at a conference bridge. Such keypresses may then interpreted and transmitted to a described feedback collection service.

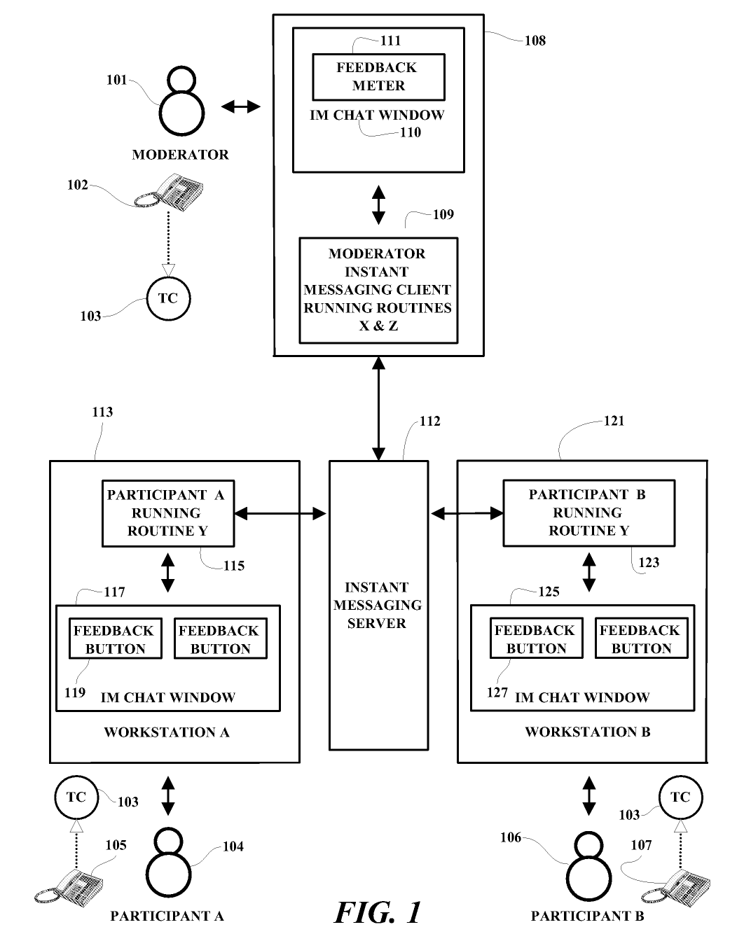

With specific reference to the illustrations presented in the drawings, FIG. 1 shows a communication system in which the present invention may be implemented in one of many possible exemplary embodiments. In the example, a teleconference meeting moderator 101 is connected through a telephone 102 to a teleconference network TC 103 to a group of participants including Participant A 104 and Participant B 106. Participant A is connected to the TC network 103 through a telephone 105 and Participant B is connected to the TC network 103 through the telephone 107. Although an audio teleconference is shown in the example for the sake of simplicity, it is understood that the teleconference may be an audio teleconference or a video teleconference. Further, there may be several participants in meetings at various sites using the speaker-phone feature of the telephones connected to the TC network 103.

In the FIG. 1 example, separate from the telecommunication network 103, the moderator 101 and each participant 104 and 106 is using a personal communication device 108, 113 and 121, respectively. The personal communication devices 108, 113 and 121 may be hard-wired personal computers, workstations or even wireless personal computer or other communication devices capable of communication with the other similar devices and running programs, such as Instant Messaging (IM) programs as herein described. Each of the devices 108, 113 and 121 is coupled to each other through a common (IM) server 112. In general, IM programs are well known and are not disclosed in any greater detail in order not to obfuscate the main features of the present invention.

Each of the communication or IM devices 108, 113 and 121 includes a display screen upon which a chat window 110, 117 and 125, respectively, is displayed. The moderator chat window 110 displays, inter alia, a participant feedback meter 111 as hereinbefore described. In addition, the moderator device 108 is configured to run or is selectively running IM program routines X and Z as herein before described. Each of the participant communication or IM devices 113 and 121 also includes an IM chat window 117 and 125, which, in turn, include feedback buttons such as buttons 119 and 127, respectively, for providing feedback to the moderator feedback meter 111. The feedback buttons may be implemented in hardware or software configurations. Each of the participant devices is configured to selectively run IM program routine Y as hereinbefore described. Using the arrangement illustrated in FIG. 1, during a teleconferenced meeting while a moderator is making a presentation for example, each of the participants A 104 and B 106 is enabled to independently and instantaneously provide feedback to the moderator which is made known to the moderator through the use of the feedback meter 111. The configuration of the system may be such that the participant input through the feedback buttons 119 and 127 may be made anonymously if desired such that the moderator receives the feedback but is unable to determine the particular participant providing the feedback.

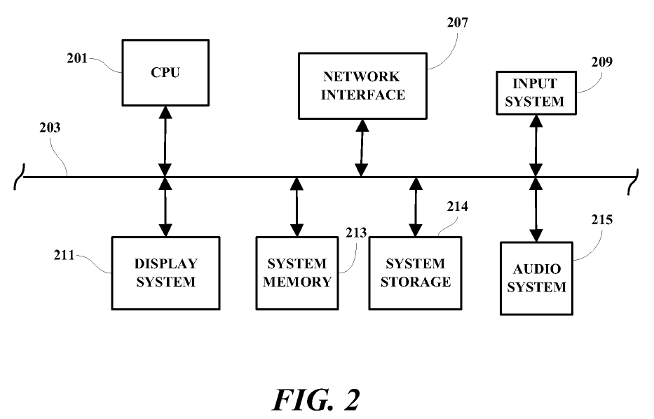

FIG. 2 illustrates several of the major components of the communication devices 108, 113 and 121. As shown, each device includes at least one central processor unit or CPU 201 which is connected to a main bus 203. Also connected to the main bus 203 is a network interface 207 for connecting to the IM server, and an input system 209. The input system includes the feedback buttons, e.g. 119, 127, and may also include a keyboard or keypad (as on a wireless implementation) as well as a mouse (as on a personal computer implementation). A display system 211, system memory 213, system storage 214 and an audio system 215 are also connected to the main bus 203. Other devices and systems may also be included and connected to the main bus 203 depending upon the particular application. As illustrated, the system shown in FIG. 2 is operable to store and run computer programs including the program routines described herein.

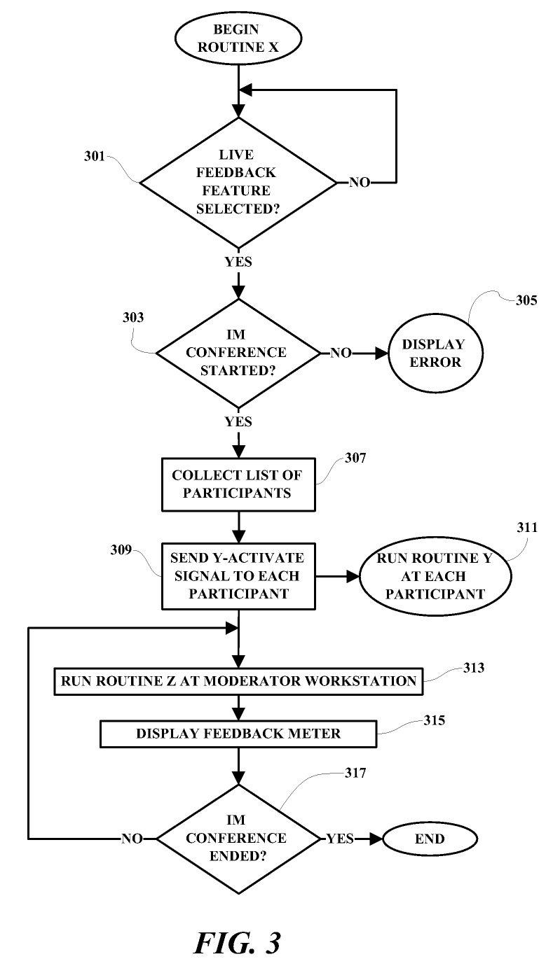

FIG. 3 illustrates a flow chart for Routine X which is running on the moderator device 108. As shown, when the live feedback feature has been selected 301, a determination is made as to whether or not the IM conference has started 303. If the IM teleconference has not started, then an error message is displayed 305. If the teleconference has begun 303, a list of participants is collected 307 and a Y-activate signal is sent 309 to each participant to activate the initiation of Routine Y on the device of each participant 311. Next, Routine Z continues to run at the moderator workstation 313 and the feedback meter is displayed 315 until it has been determined 317 that the conference has ended.

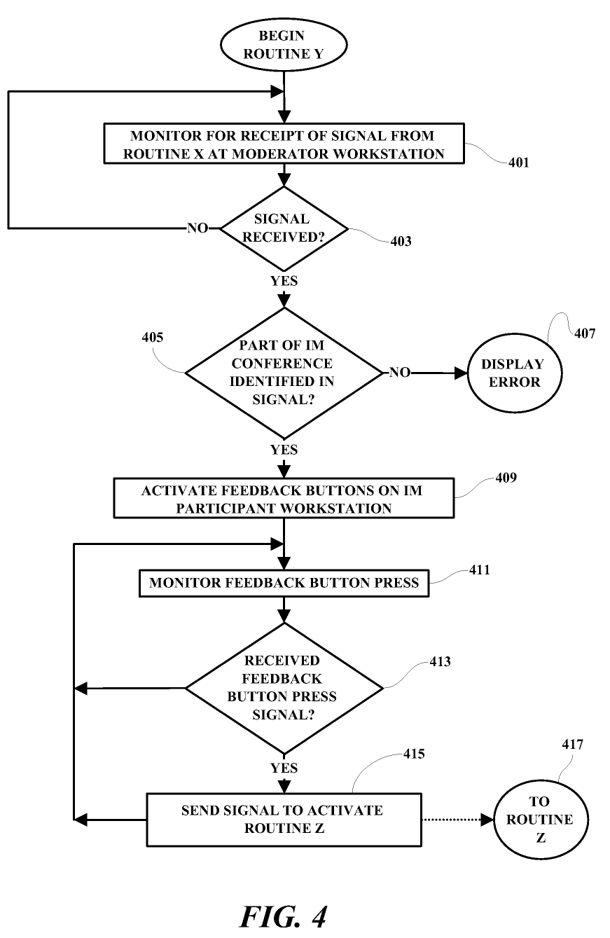

FIG. 4 illustrates a flow chart for Routine Y which is running on each participant device 113 and 121, respectively. As shown, after Routine Y has been initiated (311 FIG. 3)1 receipt of a signal from Routine X from the moderator workstation is monitored 401 and when the signal is received 403 a check is made 405 to determine if part of the IM conference is identified is identified in the received signal. This is done so that any feedback signals given by any of the participants will have the referenced portion of the teleconference identified. If part of the teleconference is not identified, an error message is displayed 407. If part of the teleconference is identified 405, the feedback buttons on the participant's IM devices are activated 409. The participant devices are monitored for feedback 411 and when feedback is received 413, a signal is sent 415 to activate Routine Z 417 at the moderator workstation.

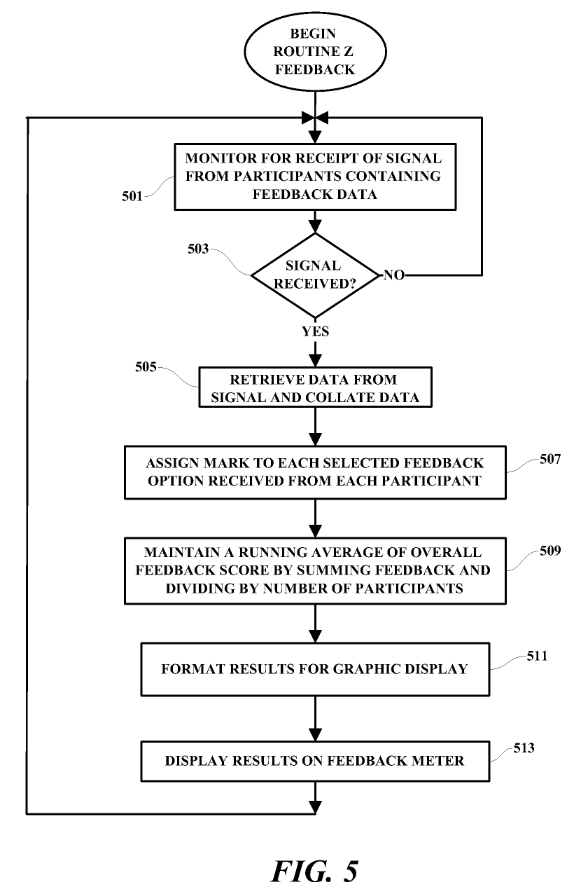

As shown in FIG. 5, when Routine Z feedback function is activated, input from the participants is monitored for receipt of feedback signals 501 when a feedback signal is received 503, the feedback data is retrieved and the data is collated 505. Next, a mark is assigned to each selected feedback option received from each participant 507. A running average of overall feedback is determined 509 by summing the feedback and dividing by the number of participants. Next, the results are formatted for graphic display 511 and displayed 513 on the feedback meter of the moderator.

The present invention may have many variations. For example, the present invention may be implemented in a system to allow the moderator to define the text and meaning (values) of feedback buttons available to participants. Further, a web-based form may be used in cases where the Instant Messaging client may not be modified. A histogram or other bar chart may be implemented showing the number of participants selecting each discrete choice, rather than, or in addition to, the average value.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored in any media, including portable or fixed, volatile or non-volatile memory media device, including CDs, RAM and “Flash” F memory, or other semiconductor, optical, magnetic or other memory storage media from which it may be loaded and/or transmitted into other media and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for processing a teleconference among a plurality of participants, said method comprising:
establishing a first connected network, said first connected network being arranged to connect said participants together whereby each participant is enabled to communicate with others of said participants in a common teleconference;
establishing a second connected network, said second connected network being arranged to connect said participants together, said second connected network being separate from said first connected network; and
providing feedback means by which each of said participants is enabled to provide feedback to a designated one of said participants, said feedback being related to teleconference content of said common teleconference, said feedback being provided through said second connected network separately from said first connected network.

2. The method as set forth in claim 1 wherein said common teleconference is an audio teleconference.

3. The method as set forth in claim 1 wherein said common teleconference is a video teleconference.

4. The method as set forth in claim 1 and further including providing said designated one of said participants with processing means for processing said feedback received from said participants.

5. The method as set forth in claim 4 and further including providing said designated one of said participants with a display device for displaying results from said feedback from said participants.

6. The method as set forth in claim 5 wherein said feedback means comprises participant input means, said participant input means further comprising selection devices, said selection devices being selectively operable by said participants to indicate approval or disapproval of a current segment of said teleconference content.

7. The method as set forth in claim 4 wherein said processing means is configured to process said feedback to provide a quantitative measure of said feedback relative to a total number of said participants connected in said common teleconference, for predetermined segments of said teleconference content.

8. A storage medium, said storage medium being selectively coupled to processing circuitry, said storage medium containing indicia readable by said processing circuitry for providing program signals for processing a teleconference among a plurality of participants, said program signals being effective for:
establishing a first connected network, said first connected network being arranged to connect said participants together whereby each participant is enabled to communicate with others of said participants in a common teleconference;
establishing a second connected network, said second connected network being arranged to connect said participants together, said second connected network being separate from said first connected network; and
providing feedback means by which each of said participants is enabled to provide feedback to a designated one of said participants, said feedback being related to teleconference content of said common teleconference, said feedback being provided through said second connected network separately from said first connected network.

9. The medium as set forth in claim 8 wherein said common teleconference is an audio teleconference.

10. The medium as set forth in claim 8 wherein said common teleconference is a video teleconference.

11. The medium as set forth in claim 8 wherein said program signals are further operable for providing said designated one of said participants with processing means for processing said feedback received from said participants.

12. The medium as set forth in claim 11 wherein said program signals are further operable for providing said designated one of said participants with a display device for displaying results from said feedback from said participants.

13. The medium as set forth in claim 8 wherein said feedback means comprises participant input means, said participant input means further comprising selection devices, said selection devices being selectively operable by said participants to indicate approval or disapproval of a current segment of said teleconference content.

14. The medium as set forth in claim 11 wherein said processing means is configured to process said feedback to provide a quantitative measure of said feedback relative to a total number of said participants connected in said common teleconference, for predetermined segments of said teleconference content.

15. A system for processing a teleconference among a plurality of participants, said system comprising:
means for establishing a first connected network, said first connected network being arranged to connect said participants together whereby each participant is enabled to communicate with others of said participants in a common teleconference;
means for establishing a second connected network, said second connected network being arranged to connect said participants together, said second connected network being separate from said first connected network; and
means for providing feedback means by which each of said participants is enabled to provide feedback to a designated one of said participants, said feedback being related to teleconference content of said common teleconference, said feedback being provided through said second connected network separately from said first connected network.

16. The system as set forth in claim 15 wherein said common teleconference is an audio teleconference.

17. The system as set forth in claim 15 wherein said common teleconference is a video teleconference.

18. The system as set forth in claim 15 and further including processing means for processing said feedback received from said participants.

19. The system as set forth in claim 18 and further including a display device for displaying results from said feedback from said participants.

20. The system as set forth in claim 19 wherein said feedback means comprises participant input means, said participant input means further comprising selection devices, said selection devices being selectively operable by said participants to indicate approval or disapproval of a current segment of said teleconference content.
